(19) United States
(12) Patent Application Publication
(10) Pub. No.: US 2021/0227249 A1
(43) Pub. Date: Jul. 22, 2021

(54) Computer Vision Systems and Methods for Compositional Pixel-Level Prediction

(71) Applicant: Insurance Services Office, Inc., Jersey City, NJ (US)

(72) Inventors: Yufei Ye, Pittsburgh, PA (US); Maneesh Kumar Singh, Lawrenceville, NJ (US); Abhinav Gupta, Pittsburgh, PA (US); Shubham Tulsiani, Pittsburgh, PA (US)

(73) Assignee: Insurance Services Office, Inc., Jersey City, NJ (US)

(21) Appl. No.: 17/151,788

(22) Filed: Jan. 19, 2021

Related U.S. Application Data
(60) Provisional application No. 62/962,412, filed on Jan. 17, 2020.
(60) Provisional application No. 62/993,800, filed on Mar. 24, 2020.

(51) Int. Cl. H04N 19/537; G06K 9/46; G06T 9/00; G06K 9/20

(52) U.S. Cl. CPC H04N 19/537; G06K 9/2054; G06T 9/002; G06K 9/46

(57) ABSTRACT

Computer vision systems and methods for compositional pixel prediction are provided. The system receives an input image frame having a plurality of entities where each entity has a location at a first time step. The system processes the input image frame to extract a representation of each entity. The system utilizes an entity predictor to determine a predicted representation of each extracted entity representation at a next time step based on each extracted entity representation and a latent variable and utilizes a frame decoder to generate a predicted frame based on the input image frame and the predicted entity representations. The system trains an encoder to predict a distribution over the latent variable based on the input image frame and a final frame of a ground truth video associated with the input image frame.

### RELATED APPLICATIONS

This application claims priority to U.S. Provisional Patent Application Ser. No. 62/962,412 filed on Jan. 17, 2020 and U.S. Provisional patent Application Ser. No. 62/993,800 filed on Mar. 24, 2020, each of which is hereby expressly incorporated by reference.

### BACKGROUND

### Technical Field

The present disclosure relates generally to the field of computer vision technology. More specifically, the present disclosure relates to computer vision systems and methods for compositional pixel-level prediction.

### Related Art

A single image of a scene allows for a remarkable number of judgments to be made about the underlying world. For example, by looking at an image, a person can easily infer what the image depicts, such as, a stack of blocks falling over, a human holding a pullup bar, etc. While these inferences showcase humans' ability to understand what is, even more remarkable is their capability to predict what will occur. For example, looking at an image of stacked blocks falling over, a person can predict how the blocks will topple. Similarly, looking at a human holding the pullup bar, a person can predict that the human will lift his torso while keeping his hands in place.

Computer vision systems are capable of modeling multiple objects in physical systems. These systems use the relationship between objects, and can predict the trajectories over a long time horizon. However, these approaches typically model deterministic processes under simple visual (or often only state based) input, while often relying on observed sequences instead of a single frame. Although some systems take raw image as input, they only make state predictions, and not pixel space prediction. Further, existing approaches apply variants of graph neural networks (“GNNs”) for future prediction, which are restricted to predefined state-spaces as opposed to pixels, and do not account for uncertainties using latent variables.

Therefore, there is a need for computer vision systems and methods capable of predicting future motions, movements, and events from a single image of a scene and at a pixel-level. These and other needs are addressed by the computer vision systems and methods of the present disclosure.

### SUMMARY

The present disclosure relates to computer vision systems and methods for compositional pixel-level prediction. The system processes input images fed into a pixel-level prediction engine to generate one or more sets of output images. For example, the input image can show three blocks falling over, and the pixel-level prediction engine would predict how the blocks fell in output images. To generate a prediction, the system uses an entity predictor module to model how at least one entity presents change in an input image. The system then uses a frame decoder module to infer pixels by retaining the properties of each entity in the input image and resolves conflicts (e.g. occlusions when composing the image). Next, the system accounts for a fundamental multi-modality in each task. Finally, the system uses a latent encoder module to predict a distribution over the latent variable u using a target video.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the overall system of the present disclosure;

FIG. 2 is a flowchart illustrating overall process steps carried out by the computer vision system of the present disclosure;

FIG. 3 is a diagram illustrating operation of the system of FIG. 1;

FIG. 4 is an illustration showing operation of the frame decoder module of the present disclosure;

FIGS. 5A-5D are illustrations showing the latent encoder module of the present disclosure and prior art approaches for future prediction;

FIG. 6 is an illustration showing an example output generated by the system of the present disclosure;

FIGS. 7A and 7B are graphs showing qualitative evaluation (using the latent u encoded by ground truth videos) of different variants of the entity predictor module of the present disclosure;

FIG. 8 is a series of illustrations showing qualitative results for composing entity representations into a frame where outputs are from variants of the frame decoder module of the present disclosure;

FIG. 9A is a graph showing an average perceptual error for predicted frames via variants of the frame decoder module of the present disclosure;

FIG. 9B is an illustration showing a visualization of the composition of the foreground masks predicted by the present disclosure for entities at different iterations;

FIGS. 10A and 10B are graphs showing the quantitative evaluations of the system of the present disclosure and of baseline models;

FIG. 11 is an illustration showing the diversity of predictions of the system of the present disclosure and three baseline models;

FIG. 12 is an illustration showing video prediction results of the system of the present disclosure;

FIG. 13 is an illustration showing the different sample futures using predicted joint locations across time;

FIGS. 14A and 14B are graphs showing error for location prediction and frame prediction, respectively, using the system of the present disclosure and baseline methods; and

FIG. 15 is a diagram illustrating sample hardware and software components capable of being used to implement the system of the present disclosure.

### DETAILED DESCRIPTION

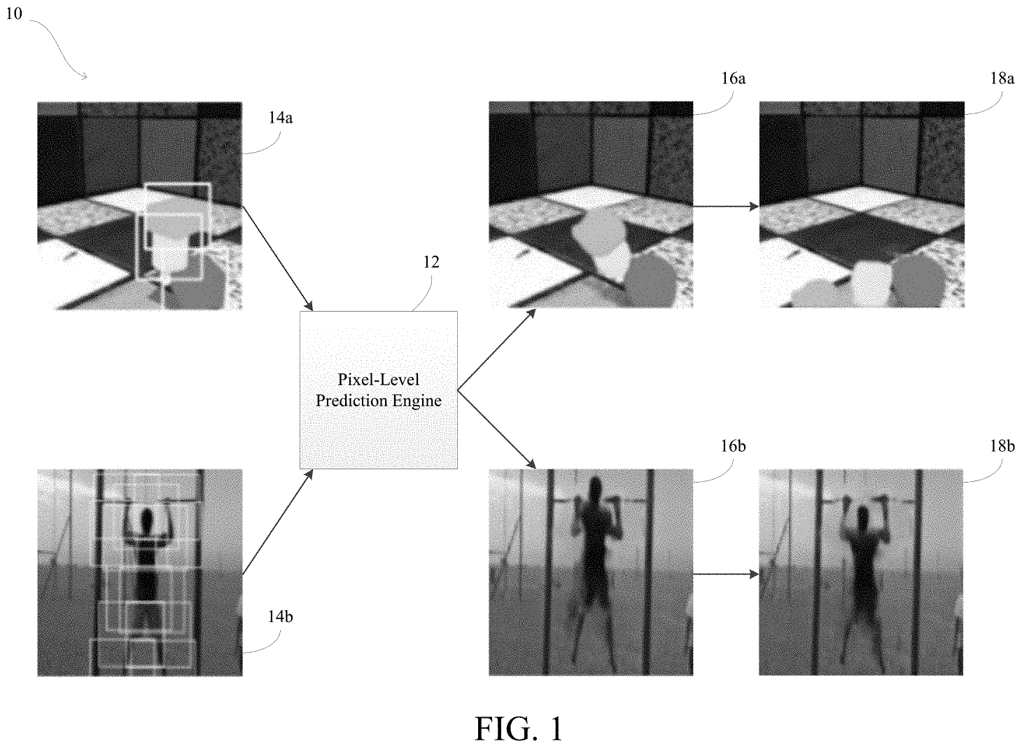

The present disclosure relates to computer vision systems and methods for compositional pixel-level prediction, as described in detail below in connection with FIGS. 1-15. Specifically, the present disclosure will discuss a system capable of predicting, from a single image of a scene and at a pixel-level, what the future will be.

FIG. 1 is a diagram illustrating the overall system, indicated general at 10. The system 10 includes a pixel-level prediction engine 12, input images 14a and 14b, first output images 16a and 16b, and second output images 18a and 18b. The input images 14a and 14b are fed into the pixel-level prediction engine 12 as input data. The pixel-level prediction engine 12 processes the input images 14a and 14b, and generates the first output images 16a and 16b, and the second output images 18a and 18b as output data. For example, input image 14a shows three blocks falling over, and the pixel-level prediction engine 12 predicts the blocks falling in output images 16a and 18a. Input image 14b shows a person on a pullup bar, and the pixel-level prediction engine 12 predicts the person pulling himself up, and letting himself down in output images 16b and 18b.

Given an input image (which may be referred to as an input frame), along with known or detected locations of entities present in the input image, the system 10 predicts a sequence of future frames. Specifically, given a starting frame f⁰ (e.g., an input image) and the location of N entities {b⁰ₙ}^{N}ₙ₌₁, the system 10 generates T future frames f¹, f², . . . , f^{T} (e.g., output images). By way of example, the pixel-level prediction engine 12 predicted output images 16a and 16b at 0.5 seconds from the input images 14a and 14b, and predicted output images 18a and 18b at 1.0 seconds from the input images 14a and 14b. It is noted that the system 10 is capable of processing a scene comprising of multiple entities, thus accounting for different dynamics and interactions, and processing an inherently multi-modal nature of a prediction task.

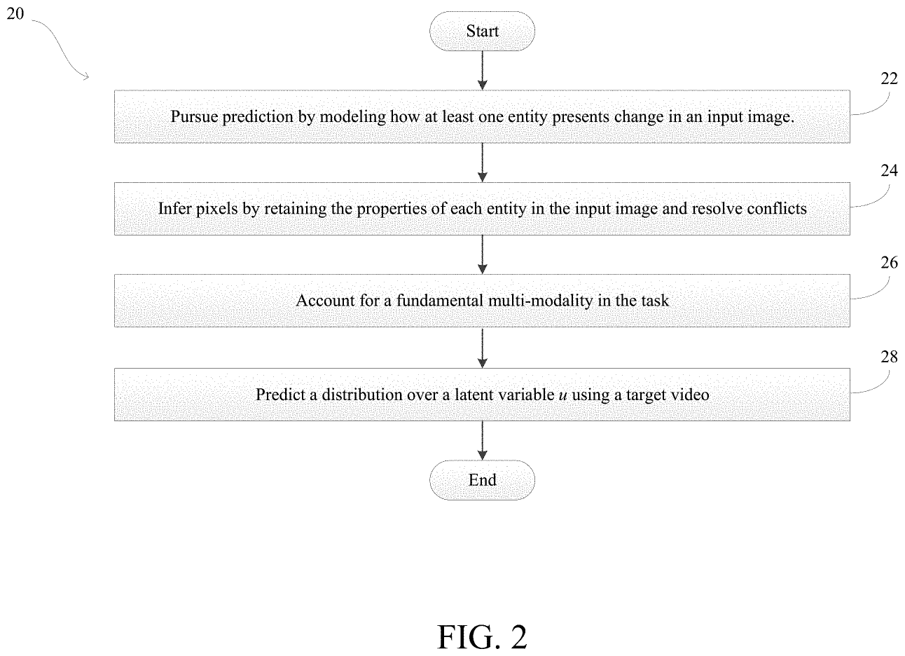

FIG. 2 is a flowchart illustrating the overall process steps being carried out by the system 10, indicated generally at method 20. In step 22, the system 10 uses an entity predictor module to pursue prediction by modeling how at least one entity presents change in an input image. Specifically, the entity predictor module predicts per-entity representations {x^{t}ₙ}^{N}ₙ₌₁≡{(b^{t}ₙ, a^{t}ₙ)}^{N}ₙ₌₁ where b^{t}ₙ denotes a predicted location, and a^{t}ₙ denotes predicted features that implicitly capture appearance for each entity. This factorization allows the pixel-level prediction engine 12 to efficiently predict the future in terms of these entities.

In step 24, the system 10 uses a frame decoder module to infer pixels by retaining the properties of each entity in the input image, respecting the predicted location, and resolving conflicts (e.g. occlusions when composing the image). In step 26, the system 10 accounts for a fundamental multi-modality in the task. Specifically, the system 10 uses a global random latent variable u that implicitly captures ambiguities across an entire video. The latent variable u, deterministically (via a learned network) yields per time-step latent variables zₜ which aid per time-step future predictions. Specifically, a predictor P takes as input the per entity representation {x^{t}ₙ} along with the latent variable zₜ, and predicts the entity representations at the next time-step {xₙ^{t+1}}≡P({x^{t}ₙ}, zₜ). The decoder D, using these predictions (and the initial frame f⁰ to allow modeling background), composes a predicted frame.

In step 28, the system 10 uses a latent encoder module to predict a distribution over the latent variable u using a target video. Specifically, the system 10 is trained to maximize the likelihood of the training sequences, comprising of terms for both the frames and the entity locations. As is often the case with optimizing likelihood in models with unobserved latent variable models, directly maximizing likelihood is intractable, and therefore, the system 10 maximizes a variational lower bound. The annotation of future frames/locations, as well as the latent encoder module, are used during training. During inference, the system 10 takes in as input only a single frame along with locations of the entities present, and generates multiple plausible future frames.

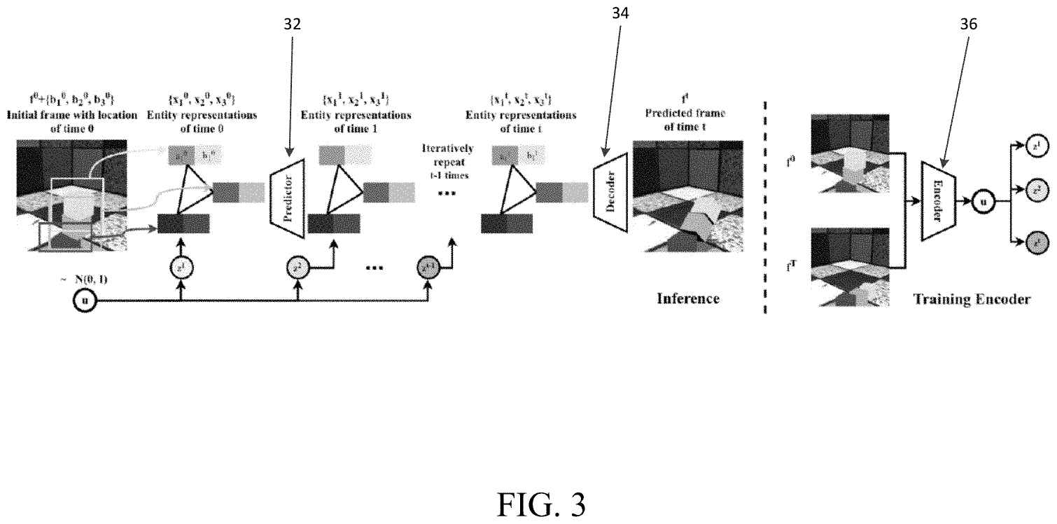

FIG. 3 is a diagram illustrating operation of the system 10 of FIG. 1. As discussed above, the pixel-level prediction engine 12 takes as input an input image with known or detected location(s) of entities. Each entity is represented as its location and an implicit feature. Given the current representations and a sampled latent variable u, the system 10 predicts, via the entity predictor module 32, the representations at the next time step. Further, the system 10, via the frame decoder module 34, composes the predicted representations to an image representing the predicted future. During training, the system 10, via the latent encoder module 36, infers the distribution over the latent variable u using the initial and final frames.

The entity predictor module will now be discussed in detail. Given per-entity locations and implicit appearance features {x^{t}ₙ}^{N}ₙ₌₁≡{(b^{t}ₙ, dₙ)}^{N}ₙ₌₁ the entity predictor module outputs the predictions for a next time step using the latent variable zₜ. An iterative application of the entity predictor module therefore allows the system 10 to predict the future frames for the entire sequence using the encodings from the initial frame. To obtain the initial input to the entity predictor module (e.g., the entity encodings at the first time step {x⁰ₙ}^{N}ₙ₌₁), the system 10 uses the known/detected entity locations {b⁰ₙ}, and extracts the appearance features {a⁰ₙ} a convolutional neural network (“CNN”) on the cropped region from the frame f⁰. For example, the system 10 can use a standard ResNet-18 CNN.

While the predictor P infers per-entity features, the entity predictor module allows for the interaction among these entities rather than predicting each of them independently (e.g., a block may or may not fall depending on the other ones around it). To enable this, the system 10 leverages a computer vision model in the graph neural network family, in particular based on Interaction Networks which take in a graph G=(V, E) with associated features for each node, and update these via iterative message passing and message aggregation. The predictor P that infers {x^{t+1}ₙ} from ({x^{t}ₙ}, zₜ) comprises of four interaction blocks, where the first block takes as input the entity encodings concatenated with the latent feature: {x^{t}ₙ⊕zₜ}^{N}ₙ₌₁. Each of these blocks performs a message passing iteration using the underlying graph, and the final block outputs predictions for the entity features for the next time step {x^{t}ₙ}^{N}ₙ₌₁≡{(b^{t}ₙ, a^{t}ₙ}^{N}ₙ₌₁. This graph can either be fully connected as with synthetic data experiments, or more structured (e.g., skeleton in human video prediction experiments).

It should be noted that the entity predictor module can comprise Interaction Networks, a Graph Convolution Network (“GCN”), or any other network having subtle or substantial differences, both in architecture and application. For example, the entity predictor module can stack multiple interaction blocks for each time step rather than use a single interaction block to update node features. Additionally, the entity predictor module can use non-linear functions as messages for better performance, rather than use a predefined mechanism to compute edge weights and use linear operations for messages.

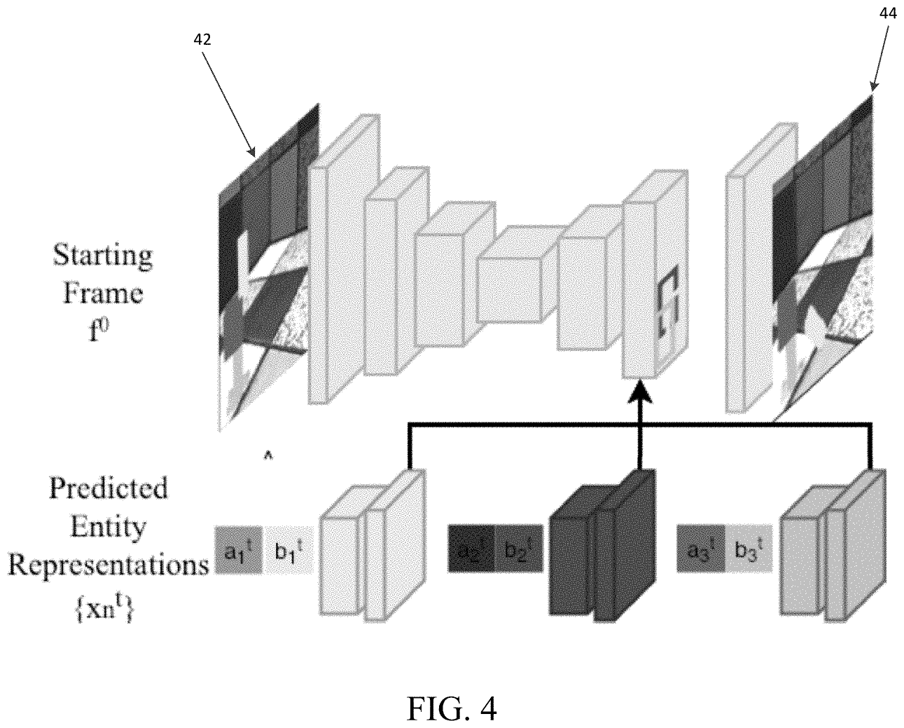

The frame decoder module will now be discussed in detail. The frame decoder module generates pixels of the frame f^{t} from a set of predicted entity representations. While the entity representations capture the moving aspects of the scene, the system 10 also can incorporate static background, and additionally use the initial frame f⁰ to do so. The decoder D, predicts f^{t}≡D({x^{t}ₙ}, f⁰). FIG. 4 is an illustration showing the frame decoder module taking in the initial frame 42 (f⁰) and the predicted entity representations at time t, and outputs the frame corresponding to the predicted future 44 (f^{t}). To compose frames from the factored input representation, the frame decoder module considers whether: a) the predicted location of the entities should be respected, b) the per-entity representations need to be fused (e.g., when entities occlude each other), and c) different parts of background may become visible as objects move.

To account for a predicted location of the entities when generating images, the frame decoder module decodes a normalized spatial representation for each entity, and warps it to the image coordinates using predicted 2D locations. To allow for the occlusions among entities, the frame decoder module predicts an additional soft mask channel for each entity, where the value of masks capture the visibility of the entities. Lastly, the frame decoder module overlays the (masked) spatial features predicted via the entities onto a canvas containing features from the initial frame f⁰, and then predicts the future frame pixels using this composed feature.

Specifically, the frame decoder module denotes by ϕ_{bg} the spatial features pre-dieted from the frame f⁰ (using, for example, a CNN with architecture similar to U-Net [a CNN with biomedical image segmentation features]). The function {(ϕ̅ₙ, M̅ₙ)=g(aₙ)}ₙ₌₁^{N} denotes the features and spatial masks decoded per-entity using an up-convolutional decoder network g. The frame decoder module first warps, using the predicted locations (predicted bounding boxes) bₙ, the features and masks into image coordinates at same resolution as ϕ_{bg}. Denoting by W a differentiable warping function (e.g., in Spatial Transformer Networks), the frame decoder module obtains the entity features and masks in the image space via Equation 1, seen below:

ϕₙ= [symbol] (ϕ̅ₙ,bₙ);Mₙ= [symbol] (M̅ₙ,bₙ) Equation 1

Warped mask and features (ϕₙ, Mₙ) for each entity are zero outside predicted bounding box bₙ, and mask Mₙ can further have variable values within this region. Using these independent background and entity features, the frame decoder module composes frame level spatial features by combining these via a weighted average. Denoting by M_{bg} a constant spatial mask (with value 0.1), the frame decoder module obtains the composed features as Equation 2, seen below:

$$φ = \frac{{φ}_{bg} ⊙ {M}_{bg} ⊕ {Σ}_{n} {φ}_{n} ⊙ {M}_{n}}{{M}_{bg} ⊕ {Σ}_{n} {M}_{n}} \qquad Equation 2$$

The composed features incorporate information from all entities at the appropriate spatial locations, allow for occlusions using the predicted masks, and incorporate the information from background. The frame decoder module then decodes the pixels for the future frame from these composed features. The system 10 can select over the spatial level where the feature composition occurs (e.g., it can happen in feature space at near the image resolution (late fusion)), or directly at pixel-level (where the variables all represent pixels), or alternatively at a lower resolution (mid/early fusion).

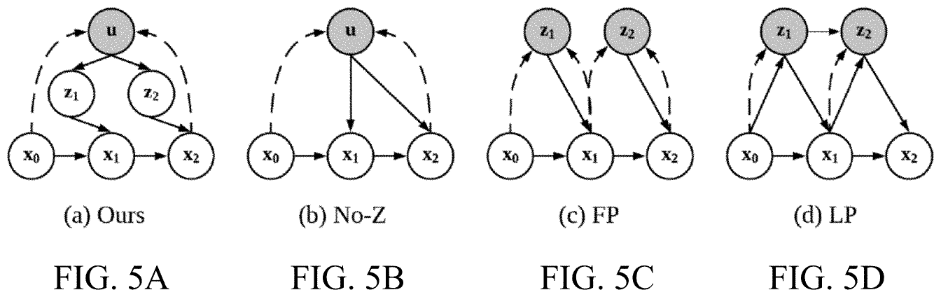

The latent encoder module will now be discussed in detail. As discussed above, the system 10 is conditioned on the latent variable u, which in turn generates per time-step conditioning variables zₜ that are used in each prediction step. FIG. 5A is an illustration of the latent encoder module. Intuitively, the global latent variable captures video-level ambiguities (e.g. where the blocks fall), the variables zₜ resolve the corresponding ambiguities in the per time-step motions. FIGS. 5B-5D are illustrations showing prior art approaches for future prediction, which do not correlate all of the zₜ's, as does the system of the present disclosure.

During training, the system 10 maximizes the variational lower bound of the log-likelihood objective (rather than marginalizing the likelihood of the sequences over all possible values of the latent variable u). This is done via training the latent encoder module, which (during training) predicts a distribution over u conditioned on a ground-truth video. For example, the system conditions on the first and last frame of the video (using, for example, a feed-forward neural network), where the distribution predicted is denoted by q(u|f⁰, f^{\hat{ }T}). Given a particular u sampled from this distribution, the system 10 recovers the {zₜ} via a one-layer long short-term memory (“LSTM”) network, which, using u as the cell state, predicts the per time-step variables for the sequence.

It is noted that the training objective can be thought of as maximizing the log-likelihood of the ground-truth frame sequence {f^{\hat{ }t}}^{T}ₜ₌₁. The system can further use training-time supervision for the locations of the entities {{b^{\hat{ }t}ₙ}^{N}ₙ₌₁}^{T}ₜ₌₁. While this objective has an interpretation of log-likelihood maximization, for simplicity, the system 10 can consider it as a loss L composed of different terms, where the first L_{pred} encourages the future frame and location prediction to match the ground-truth. L_{pred} is can be expressed by Equation 3, seen below:

$${L}_{pred} = {\sum }_{t = 1}^{T} ( {‖ 𝒟 ( \{ {x}_{n}^{t} \} , {f}^{0} ) - \hat{{f}^{t}} ‖}_{1} + {λ}_{1} {\sum }_{n = 1}^{N} {‖ {b}_{n}^{t} - {\hat{b}}_{n}^{t} ‖}^{2} ) \qquad Equation 3$$

The second component corresponds to enforcing an information bottleneck on the latent variable distribution, expressed by Equation 4, below:

L_{enc}=KL|q(u)∥ [symbol] (0,I)] Equation 4

Lastly, to further ensure that the frame decoder module generates realistic composite frames, the system 10 includes an auto-encoding loss that enforces the system 10 to generate the correct frame when given entities representations {x^{\hat{ }t}ₙ} extracted from f^{\hat{ }t} (and not the ones frames) as input. This is expressed by Equation 5, below:

$${L}_{dec} = {\sum }_{t = 0}^{T} {‖ 𝒟 ( \{ {\hat{x}}_{n}^{t} \} , {f}^{0} ) - \hat{{f}^{t}} ‖}_{1} \qquad Equation 5$$

The system 10 determines the total loss as L=L_{dec}+L_{pred}+λ2L_{enc}, with hyper-parameter λ2 determining the trade-offs among accurate predictions and information bottleneck in random variable.

Testing of the above systems and methods will now be discussed in greater detail. A goal of the testing is to show qualitative and quantitative results highlighting the benefits the system 10, and its modules (the entity predictor module, the frame decoder module, and the latent encoder module). First, the testing validates the system 10 and methods of the present disclosure using a synthetic dataset comprised of stacked objects that fall over time (e.g., a Shapestacks dataset), and presents several ablations comparing each module with relevant baselines. The testing also presents qualitative and quantitative results on a Penn Action dataset, which comprises of humans performing various activities. The two datasets highlight the ability of the system 10 to work in different scenarios, one where the ‘entities’ correspond to distinct objects, and another where the ‘entities’ are the joints of the human body. In both settings, the testing evaluates the predicted entity locations using average mean square error and the quality of generated frames using the Learned Perceptual Image Patch Similarity (“LPIPS”) metric.

Shapestacks is a synthetic dataset containing stacks of objects falling under gravity with diverse blocks and configurations. The testing used a subset of this dataset containing three blocks. The blocks can be cubes, cylinders or balls in different colors. The data is generated by simulating the given initial configurations in advance physics simulator MuJoCo for 16 steps. The testing used 1320 videos for training, 281 clips for validation and 296 clips for testing. While the setting is deterministic under perfect state information (precise 3D position and pose, mass, friction, etc.), the prediction task is ambiguous given an image input.

The testing used the Shapestacks dataset to validate the different modules (e.g., the entity predictor module, the frame decoder module, and the latent encoder module) for the latent variables. A subtle detail in the evaluation is that at inference, the prediction is dependent on a random variable u, and while only a single ground-truth is observed, multiple predictions are possible. To account for this, the system 10 used the mean u predicted by the latent variable module. When ablating the choices of the latent representation itself, the system used (K=100) prediction samples and report the lowest scoring error.

The testing showed that the entity predictor module factorized prediction over per-entity locations and appearance, and that allowed reasoning via GNNs helps improve prediction. Specifically, the system 10 compared against two alternate models: a) a No-Factor model and b) a No-Edge model. The No-Edge model does not allow for interactions among entities when predicting the future. The No-Factor model does not predict a per-entity appearance but simply outputs a global feature that is decoded to foreground appearance and mask. The No-Factor model takes as input (and outputs) the per-entity bounding boxes, (these are not used via the frame decoder module).

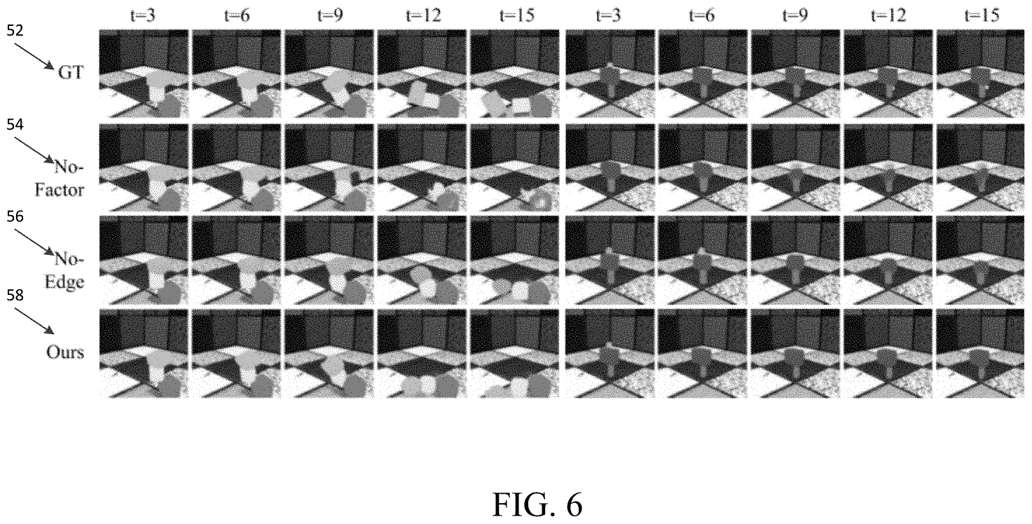

FIG. 6 is an illustration showing video prediction results using the system of the present disclosure 58, and baseline model (such as a ground truth (“GT”) model 52, No-Factor model 54, and No-Edge model 56). Each frame is visualized after three time-steps. The No-Factor model generates plausible frames at the beginning and performs well for static entities. However, at later time steps, entities with large range of motion diffuse because of the uncertainty. In contrast, entities generated by the system 58 have a clearer boundary along time. The No-Edge model does not accurately predict block orientations as it requires more information about relative configuration, and further changes the colors over time. In contrast, blocks generated by the system 58 gradually rotate and fall over and colors are learned to remain the same.

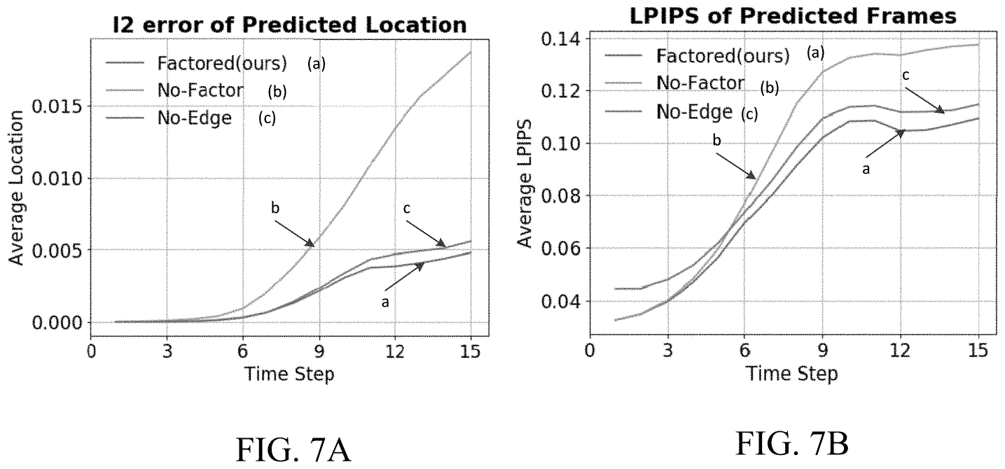

FIGS. 7A and 7B are graphs showing qualitative evaluation (using the latent u encoded by ground truth videos) of different variants of the entity predictor module. Specifically, FIG. 7A shows an average location error for predicted entities over time. FIG. 7B shows an average perceptual error of predicted frames. As seen, the system of the present disclosure has a lower average location error and a lower average perceptual error that the No-Factor model and the No-Edge model.

The No-Factor model shows the benefits of composing different features for each entity while accounting for their predicted spatial location, the testing ablated whether this composition should directly be at a pixel-level or at some implicit feature level (early fusion, mid fusion, or late fusion). Across all the ablations, the number of layers in the frame decoder module remained the same, and only the level at which features from entities are composed differed.

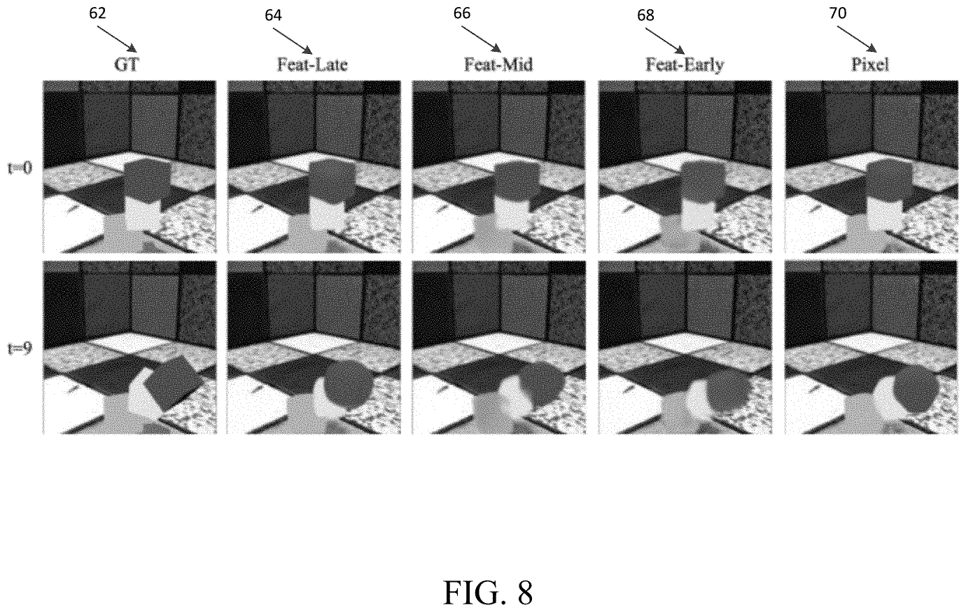

FIG. 8 is a series of illustrations showing the qualitative result for composing entity representations into a frame where outputs are from variants of the frame decoder module performed in the GT model 62, late fusion 64, mid fusion 66, early fusion 68 (in feature space), or directly in pixel space 70. Specifically, the first row visualizes decodings from an initial frame (t=0), and the second row demonstrates decoding from predicted features for a later time-step (t=9). While both the late stage feature space fusion and the pixel-level fusion reconstruct the initial frame faithfully, the pixel-level fusion introduces artifacts for future frames. The mid/early fusion alternates do not capture details well.

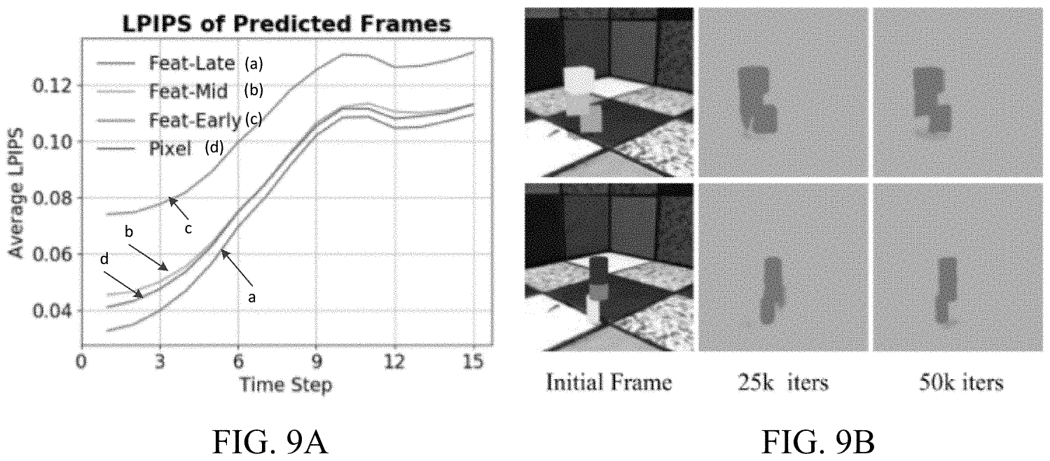

FIG. 9A is a graph showing an average perceptual error for predicted frames via variants of the frame decoder module. FIG. 9B is an illustration showing a visualization of the composition of the foreground masks predicted for the entities at different iterations. To further analyze the predictions from the frame decoder module, the generated soft masks of FIGS. 9A and 9B are visualized. The values indicate the probability of the pixel belongs a foreground the entity. It is noted that this segmentation emerges without direct supervision, but only using location and frame-level supervision.

During testing, the latent variables used in the pixel-level prediction engine differed from using a per time-step random variable zₜ. The approach of the system 10 was compared to other approaches. Specifically, a No-Z baseline approach directly uses u across every time steps, instead of predicting a per time-step z^{t}. In Fixed Prior (“FP”) and Learned Prior (“LP”) baselines, the random variables are sampled per time-step, either independently (as in FP), or depending on previous prediction (as in LP). During training, both FP and LP models (baselines) are trained using an encoder that predicts zₜ using the frames f^{t} and f^{t=1} (instead of using f⁰ and f^{T} to predict u as in the system of the present disclosure).

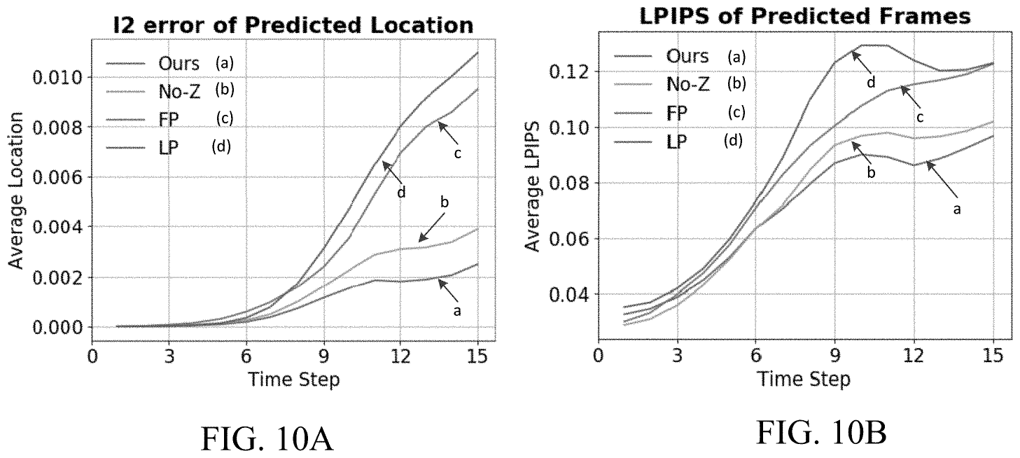

To evaluate these different choices, given an initial frame from a test sequence, K=100 video predictions are sampled from each model, and the lowest error among these is measured (this allows evaluating all methods while using same information, and not penalizing diversity of predictions). The quantitative evaluations of these methods is shown in the graphs of FIGS. 10A and 10B. It is noted that the system of the present disclosure does well for both location error and frame perceptual distance over time.

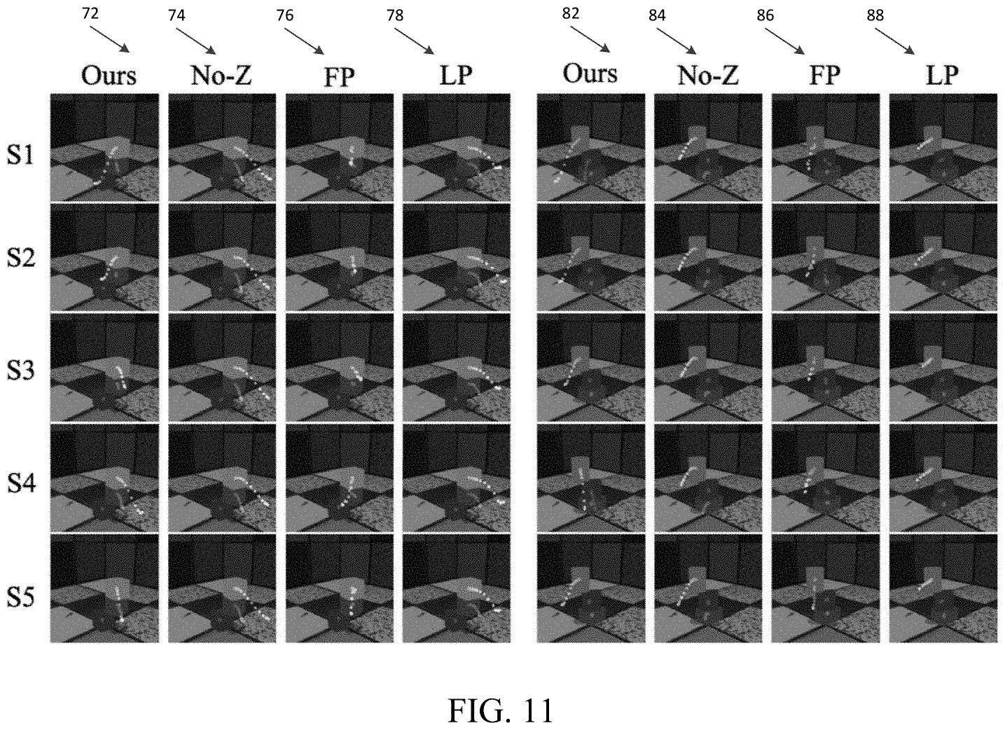

FIG. 11 is an illustration showing the diversity of predictions of the system of the present disclosure 72, 82 and three baseline models (a No-Z model 74, 84, an FP model 76, 86, and an LP model 78, 88) using five random samples in the form of trajectories of entity locations. Specifically, FIG. 11 shows the predicted centers of entities over time overlaid on top of an initial frame. As seen, the direction of trajectories from the No-Z model 74, 84 does not change across samples. The FP model 76, 86 has issues maintaining consistent motions across time-steps as during each time-step, an independent latent variable is sampled. The LP model 78, 88 performs well compared to the FP model 76, 86, but still has similar issues. Compared to the baselines, the use of a global latent variable allows the system of the present disclosure to sample produce consistent motions across a video sequence, while also allowing diverse predictions across samples.

Penn Action is a real video dataset of people playing various indoor and outdoor sports with an annotation of human joint locations. In an experiment, the system of the present disclosure was trained using Penn Action to generate video sequences of 1 second at 8 frames per second (“FPS”) given an initial frame. The Penn Action dataset comprises of a) diverse backgrounds, b) noise in annotations, and c) multiple activity classes with different dynamics.

The parameters of the present system used for this dataset is the same as that in the Shapestacks experiment, with the modification that the graph used for the interactions in the entity predictor module is based on the human skeleton, and not fully-connected. If some joint is missing in the video, the system instead links the edge to a parent. It is noted that while the graph depends on the skeleton, interaction blocks are the same across each edge. The following subset of categories was used: bench press, clean and jerk, jumping jacks, pull up, push up, sit up, and squat; all related to gym activities because most videos in these classes do not have camera motion and their background are similar within these categories. The categories are diverse in scale of people, human poses, and view angles. The same scenes do not appear in both sets, resulting in 290 clips for training and 291 for testing. To reduce overfitting, the present system augments data on the fly, including randomly selecting a starting frame for each clip, random spatial cropping, etc.

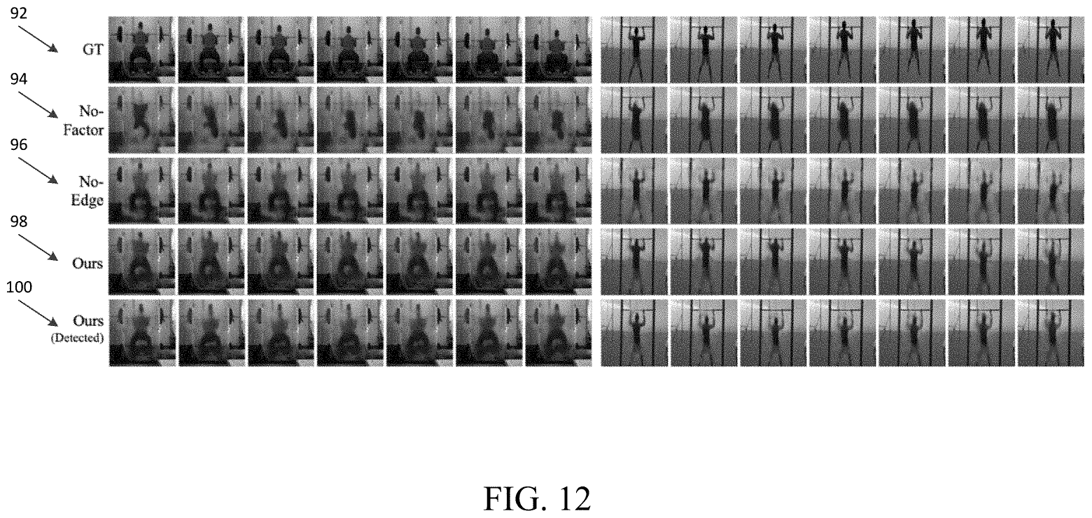

FIG. 12 is an illustration showing video prediction results of the present system 98, 100 using the latent variable u encoded with access to a final frame compared to baseline models (e.g., the GT model 92, the No-Factor model 94, and the No-Edge model 96). The last row visualizes the results of the present system when entity (joint) locations are detected instead of annotated in an initial frame. It is noted that the No-Factor model 94 cannot directly generate plausible foreground entities, while the No-Edge model 96 does not compose well. Further, it is shown that replacing annotated key-points with detected key-points (during interference) demonstrates that the requirement of locations of the entities as input for inference is not a bottleneck in applicability.

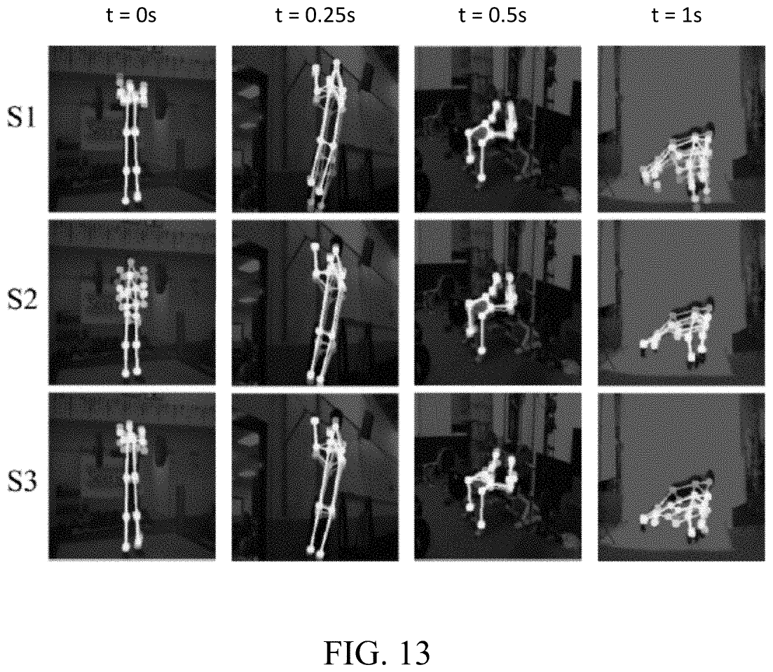

FIG. 13 is an illustration showing the different sample futures (S1, S2, and S3) using predicted joint locations across time (t=0s, t=0.25s, t=0.5s, and t=1s). The present system learns the boundary of the human body and how they composite to the human body even when the entities heavily overlap. Further, the model learns different types of dynamics for different sports. For example, during a pull-up, the legs move more with the hands still, while in clean and jerk, the legs almost remain at the same place.

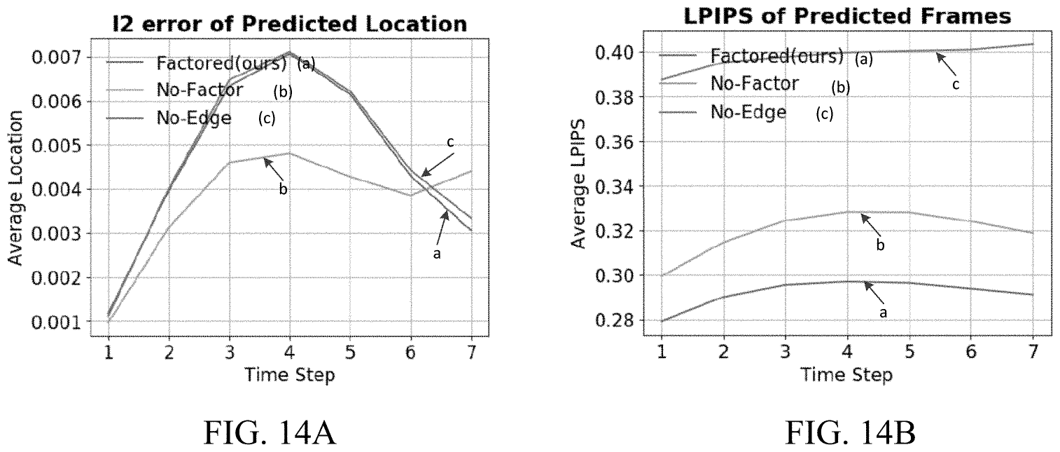

FIGS. 14A and 14B are graphs showing error for location prediction and frame prediction, respectively, using the present system and the baseline methods. The baseline methods include the No-Factor method and the No-Edge method. For each sequence, the error is computed using the best of 100 random samples.

The architecture of the entity predictor module, the frame decoder module, and the latent encoder module will now be discussed. The entity predictor module leverages the graph neural network family, whose learning process can be abstracted to iterative message passing and message aggregation. In each round of message passing, each node (edge) is a pa-rameterized function of their neighboring node and edges, which updates the parameters by back propagation. The architecture of the entity predictor module can be expressed by instantiating the message passing and aggregation operation as seen in Equations 6 and 7 below, where for the l-th layer of message passing, it consists of two operations:

$$\begin{matrix}v \to {\text{e} \text{:} \text{e}}_{i , j}^{( l )} = {f}_{v \to e}^{( l )} [ {v}_{i}^{( l )} ⊕ {v}_{j}^{( l )} ] & Equation 6 \\ e \to {\text{v} \text{:} \text{v}}_{i}^{( l + 1 )} = {f}_{e \to v}^{( l )} [ POOL [ {e}_{i , j}^{( l )} \vert ( i , j ) & Equation 7\end{matrix}$$

The system 10 performs node-to-edge passing f^{(l)}_{v→e} where edge embeddings are implicitly learned. Then, the system 10 performs edge-to-node f^{(l)}_{v→e} operation given the updated edge embeddings. The message passing block can be stacked to arbitrary layers to perform multiple rounds of message passing between edge and node. For example, stack four blocks can be stacked. For each block, f^{(l)}_{v→e}, f^{(l)}_{e→v} are both implemented as a single fully connected layer. The aggregation operator is implemented as an average pooling. Connection expressed in the edge set can be either from an explicitly specified graph, or a fully connected graph when the relationship is not explicitly observed.

The frame decoder module uses a backbone of Cascaded Refinement Networks. Given feature in the shape of (N, D, h₀, w₀) either from entity predictor module or a background feature, the frame decoder module upsamples the shape at the end of every unit. Each unit comprises of Conv→Batch→LeakyRelu. When the entity features are warped to image coordinates, the spatial transformation is implemented as a forward transformation to sharpen entities.

At training, the latent encoder module takes in the concatenated features of two frames and applies a one layer neural network to obtain a mean and a variance of u, where the system 10 resamples with reparameterization at training time. The resampled u′ is fed into a one-layer LSTM network as a cell unit to generates a sequence of z′. The system 10 optimizes the total loss with an Adam optimizer in learning rate 1e−4, λ1=100, λ2=1e−3. The dimensionality of latent is 8, i.e., |u|=|z^{t}|=8. The location feature is represented as the center of entities |b|=2, and the appearance feature is represented as |a|=32. The region of each entity is set to a large enough fixed width and height to cover the entity, such as, for example, d=70. The generated frames are in resolution of 224×224. It should be understood that these parameters are by way of example, and that those skilled in the art would be able to use different parameters with the system of the present disclosure.

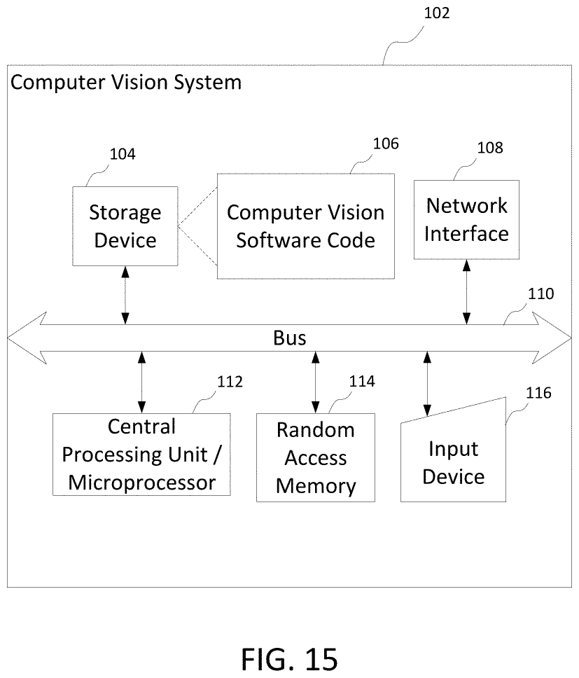

FIG. 15 is a diagram showing a hardware and software components of a computer system 102 on which the system of the present disclosure can be implemented. The computer system 102 can include a storage device 104, computer vision software code 106, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 102 could be a networked computer system, a personal computer, a server, a smart phone, tablet computer etc. It is noted that the server 102 need not be a networked server, and indeed, could be a stand-alone computer system.

The functionality provided by the present disclosure could be provided by computer vision software code 106, which could be embodied as computer-readable program code stored on the storage device 104 and executed by the CPU 112 using any suitable, high or low level computing language, such as Python, Java, C, C++, C #, .NET, MATLAB, etc. The network interface 108 could include an Ethernet network interface device, a wireless network interface device, or any other suitable device which permits the server 102 to communicate via the network. The CPU 112 could include any suitable single-core or multiple-core microprocessor of any suitable architecture that is capable of implementing and running the computer vision software code 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for compositional pixel prediction, comprising:
a memory; and
a processor in communication with the memory, the processor:
receiving an input image frame having at least one entity, the at least one entity having a location at a first time step,
processing the input image frame to extract an entity representation of the at least one entity,
utilizing an entity predictor to determine a predicted representation of the entity representation at a next time step based on the entity representation and a latent variable, and
utilizing a frame decoder to generate a predicted frame based on the input image frame and the predicted representation.

2. The system of claim 1, wherein the processor extracts the entity representation using a neural network on a cropped region of the input image frame, the entity representation being indicative of an appearance feature and the location of the entity at the first time step.

3. The system of claim 2, wherein the neural network is a convolutional neural network.

4. The system of claim 1, wherein the predicted representation is indicative of a predicted appearance feature and a predicted location of the entity representation at the next time step.

5. The system of claim 1, wherein the entity predictor is an Interaction Networks or a graph convolution network and determines an interaction of the predicted representation.

6. The system of claim 1, wherein the frame decoder is an up-convolutional decoder network and generates the predicted frame by:
decoding a normalized spatial representation for the predicted representation and warping the normalized spatial representation to coordinates of the input image frame,
predicting a soft mask channel for the predicted representation,
overlaying the soft mask channel onto the input image frame, and
decoding pixels of the predicted frame based on overlaid features of the soft mask channel and the input image frame.

7. The system of claim 1, wherein the processor trains an encoder to predict a distribution over the latent variable based on the input image frame and a final frame of a ground truth video associated with the input image frame.

8. A method for compositional pixel prediction by a computer vision system, comprising the steps of:
receiving an input image frame having at least one entity, the at least one entity having a location at a first time step,
processing the input image frame to extract an entity representation of the at least one entity,
determining, by an entity predictor, a predicted representation of the entity representation at a next time step based on the entity representation and a latent variable, and
generating, by a frame decoder, a predicted frame based on the input image frame and the predicted representation.

9. The method of claim 8, further comprising the step of extracting the entity representation using a neural network on a cropped region of the input image frame, the entity representation being indicative of an appearance feature and the location of the entity at the first time step.

10. The method of claim 9, wherein the neural network is a convolutional neural network.

11. The method of claim 8, wherein the predicted representation is indicative of a predicted appearance feature and a predicted location of the entity representation at the next time step.

12. The method of claim 8, wherein the entity predictor is an Interaction Networks or a graph convolution network and determines an interaction of the predicted representation.

13. The method of claim 8, wherein the frame decoder is an up-convolutional decoder network and generates the predicted frame by:
decoding a normalized spatial representation for the predicted representation and warping the normalized spatial representation to coordinates of the input image frame,
predicting a soft mask channel for the predicted representation,
overlaying the soft mask channel onto the input image frame, and
decoding pixels of the predicted frame based on overlaid features of the soft mask channel and the input image frame.

14. The method of claim 8, further comprising the step of training an encoder to predict a distribution over the latent variable based on the input image frame and a final frame of a ground truth video associated with the input image frame.

15. A non-transitory computer readable medium having instructions stored thereon for compositional pixel prediction by a computer vision system, comprising the steps of:
receiving an input image frame having at least one entity, the at least one entity having a location at a first time step,
processing the input image frame to extract an entity representation of the at least one entity,
determining, by an entity predictor, a predicted representation of the entity representation at a next time step based on the entity representation and a latent variable, and
generating, by a frame decoder, a predicted frame based on the input image frame and the predicted representation.

16. The non-transitory computer readable medium of claim 15, further comprising the step of extracting the entity representation using a neural network on a cropped region of the input image frame, the entity representation being indicative of an appearance feature and the location of the entity at the first time step.

17. The non-transitory computer readable medium of claim 15, wherein the predicted representation is indicative of a predicted appearance feature and a predicted location of the entity representation at the next time step.

18. The non-transitory computer readable medium of claim 15, wherein the entity predictor is an Interaction Networks or a graph convolution network and determines an interaction of the predicted representation.

19. The non-transitory computer readable medium of claim 15, wherein the frame decoder is an up-convolutional decoder network and generates the predicted frame by:
decoding a normalized spatial representation for the predicted representation and warping the normalized spatial representation to coordinates of the input image frame,
predicting a soft mask channel for the predicted representation,
overlaying the soft mask channel onto the input image frame, and
decoding pixels of the predicted frame based on overlaid features of the soft mask channel and the input image frame.

20. The non-transitory computer readable medium of claim 15, further comprising the step of training an encoder to predict a distribution over the latent variable based on the input image frame and a final frame of a ground truth video associated with the input image frame.
